(19) United States
(12) Patent Application Publication
(10) Pub. No.: US 2007/0241548 A1
(43) Pub. Date: Oct. 18, 2007

(54) Steering wheel retracting device for vehicle

(76) Inventor: Jian Jhong Fong, Changhua (TW)

Correspondence Address: BANGER SHIA, 204 CANYON CREEK, VICTORIA, TX, 77901-3695, US

(21) Appl. No.: 11/403,765

(22) Filed: Apr. 13, 2006

(51) Int. Cl. B60K 28/10; B62D 1/00; B60R 21/0136

(52) U.S. Cl. 280/777; 280/734; 180/274

(57) ABSTRACT

A steering wheel retracting device includes a steering wheel of a vehicle, and a moving device for moving the steering wheel relative to the vehicle to selectively move the steering wheel away from a vehicle driver when a car accident is happened. A cylinder housing may be attached to the vehicle, and a shaft is engaged through the cylinder housing for coupling the steering wheel to the front wheels of the vehicle. A piston rod is slidably engaged onto the shaft and has a piston slidably engaged in the cylinder housing, and an actuator is coupled to the cylinder housing for selectively moving the piston relative to the cylinder housing to retract the steering wheel away from the vehicle driver.

### BACKGROUND OF THE INVENTION

1. Field of the Invention

The present invention relates to a steering wheel retracting device, and more particularly to a steering wheel retracting device for attaching to vehicles and for retracting the steering wheel of the vehicle when the vehicle is hit or stricken onto other objects, and thus for preventing the vehicle driver from striking onto the steering wheel when a car accident is happened.

2. Description of the Prior Art

Various kinds of typical shock and energy dissipating devices or assemblies have been developed and attached to various vehicles for absorbing and dissipating the hits or shocks that may be transmitted to the vehicle drivers or passengers and for preventing the vehicle drivers or passengers from being hurt.

For example, various kinds of typical shock and energy dissipating devices have been developed and attached to the bumpers or the other portions of the vehicles for absorbing and dissipating the hits or shocks that may be transmitted to the vehicle drivers or passengers.

However, when a car accident is happened or when the vehicle is hit by other objects or when the vehicle is stricken onto other objects, the vehicle driver may also be violently or seriously stricken onto the steering wheel due to the moment of inertia, such that the vehicle driver may also be seriously hurt during the car accident.

For preventing the vehicle driver from being stricken onto the steering wheel and for safely protecting the vehicle driver and/or the passengers, various kinds of air bags have been developed and attached to the front portions of the vehicles for being inflated when a car accident is happened or when the vehicle is hit by other objects or when the vehicle is stricken onto other objects.

However, actually, when a car accident is happened or when the vehicle is hit by other objects or when the vehicle is stricken onto other objects, the air bags will be quickly inflated by explosive air or other explosive gases, and the quickly or suddenly explosion of the air bags may apply a great force against the vehicle drive(r and/or the passengers, such that many of the vehicle driver and/or the passengers have been hurt by the air bags instead of being hurt by the car accidents.

In addition, it is to be noted that the steering wheel is located right in front of the vehicle driver and located very close to the vehicle driver, and the distance between the steering wheel and the vehicle driver is too short for the air bags to be inflated, such that the quickly or suddenly explosion of the air bags may apply a great force against the vehicle driver and may cause internal injury to the vehicle driver.

The present invention has arisen to mitigate and/or obviate the afore-described disadvantages of the conventional steering wheels for vehicles.

### SUMMARY OF THE INVENTION

The primary objective of the present invention is to provide a steering wheel retracting device for attaching to a vehicle and for retracting the steering wheel of the vehicle and/or for moving the steering wheel away from the vehicle driver when the vehicle is hit or stricken onto other objects, and thus for preventing the vehicle driver from striking onto the steering wheel when a car accident is happened.

In accordance with one aspect of the invention, there is provided a steering wheel retracting device comprising a steering wheel provided in a vehicle, and a moving device for moving the steering wheel relative to the vehicle to selectively move the steering wheel away from a vehicle driver when a car accident is happened, and thus for preventing the vehicle driver from quickly hitting or striking onto the steering wheel, and thus for dissipating the force of the vehicle driver that may be applied onto the steering wheel.

The moving device includes a cylinder housing for attaching to the vehicle and having a chamber formed therein, and a shaft engaged through the chamber of the cylinder housing and having an upper portion attached to the steering wheel. The cylinder housing includes at least one bearing disposed between the cylinder housing and the shaft.

The shaft includes a bore formed therein, a coupling device is provided for coupling to front wheels of the vehicle and includes a link having an upper portion engageable into the bore of the shaft for coupling the steering wheel to the front wheels of the vehicle. The shaft includes at least one guiding rib formed therein and extended into the bore of the shaft, and the link includes at least one guiding rib provided on the upper portion of the link for engaging with the guiding rib of the shaft and allowing the link of the coupling device to be rotated by the shaft.

The moving device includes a piston rod slidably engaged onto the shaft and includes a piston provided on the piston rod and slidably engaged in the chamber of the cylinder housing for separating the chamber of the cylinder housing into a first space and a second space, and an actuator coupled to the second space of the cylinder housing for selectively moving the piston relative to the cylinder housing.

A bearing device may further be provided and coupled between the piston rod and the shaft for rotatably coupling the piston rod and the shaft together but for preventing the piston rod and the shaft from moving axially relative to each other. The bearing device includes at least one thrust bearing and/or at least one needle bearing disposed between the piston rod and the shaft. A retaining ring may further be provided and engaged between the piston rod and the shaft for rotatably coupling the piston rod and the shaft together.

The moving device includes at least one breakable latch for coupling the piston rod to the vehicle and for being selectively broken when the piston rod is moved relative to the cylinder housing. The moving device includes a frame for attaching to the vehicle and for attaching the breakable latch.

The actuator includes an outwardly extended piston rod for being actuated to supply a pressurized fluid to the second space of the cylinder housing. The actuator includes at least one check valve and/or at least one relief valve coupled between the cylinder housing and actuator.

The moving device includes an actuating device having a piston rod coupled to the cylinder housing for selectively moving the cylinder housing and the steering wheel away from the vehicle driver. The actuating device may be attached to or supported by the frame. The actuator may be coupled to the actuating device for selectively actuating the actuating device to move the cylinder housing and the steering wheel away from the vehicle driver.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view illustrating an attachment of a steering wheel retracting device in accordance with the present invention onto a vehicle;

FIG. 2 is an enlarged partial cross sectional view of the steering wheel retracting device;

FIG. 3 is a further enlarged partial cross sectional view of the steering wheel retracting device;

FIG. 4 is a partial perspective view of the steering wheel retracting device;

FIG. 5 is a partial exploded view of the steering wheel retracting device;

FIG. 6 is a partial cross sectional view similar to FIG. 1, illustrating the operation of the steering wheel retracting device for the vehicle; and

FIG. 7 is an enlarged partial cross sectional view similar to FIG. 2, illustrating the operation of the steering wheel retracting device for the vehicle.

### DETAILED DESCRIPTION OF THE PREFERRED EMBODIMENT

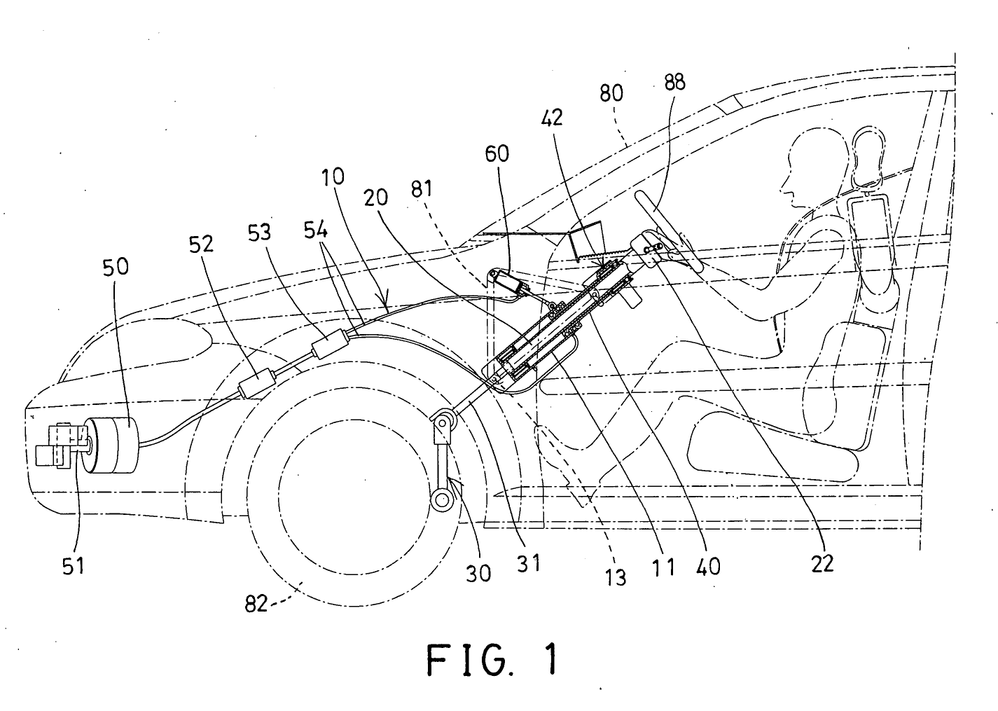

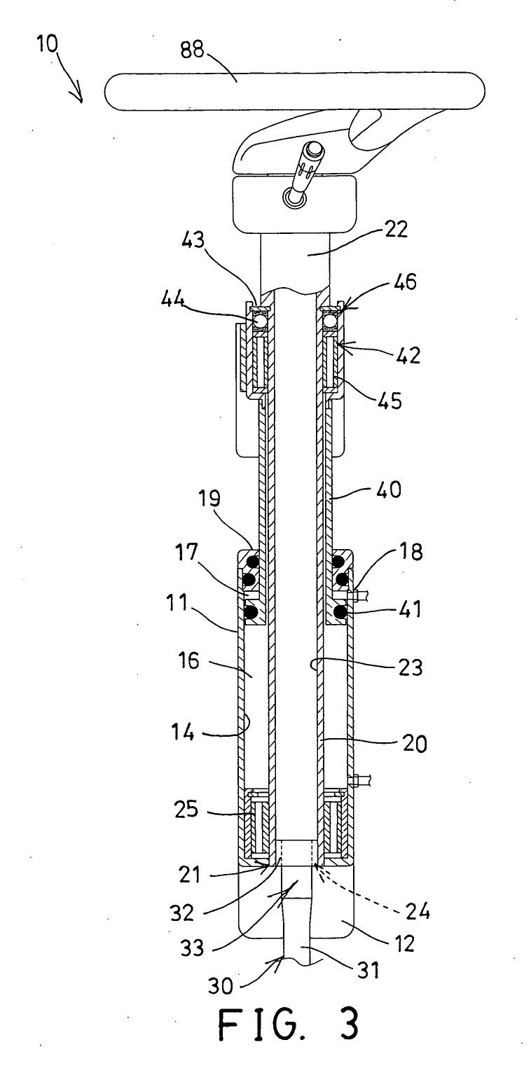

Referring to the drawings, and initially to FIGS. 1-5, a steering wheel retracting device 10 in accordance with the present invention is provided for attaching to a vehicle 80, such as for attaching to a steering wheel 88 of the vehicle 80, and for selectively retracting the steering wheel 88 of the vehicle 80 when the vehicle 80 is hit by other objects or when the vehicle is stricken onto other objects, and thus for preventing the vehicle driver from striking onto the steering wheel 88 when the car accident is happened. The vehicle 80 may further include a frame 81 disposed therein and located in front of the vehicle driver for supporting the steering wheel retracting device 10.

The steering wheel retracting device 10 comprises a cylinder housing 11 attached or secured to the vehicle 80, for example, the cylinder housing 11 includes a base member 12 attached or secured to the vehicle 80, such as secured to the frame 81 of the vehicle 80 with one or more fasteners 13, and the cylinder housing 11 includes a chamber 14 formed therein. A shaft 20 is rotatably and slidably engaged through the chamber 14 of the cylinder housing 11 and includes a lower end or lower portion 21 extendible out of the chamber 14 of the cylinder housing 11, and includes an upper end or upper portion 22 attached or secured to the steering wheel 88 of the vehicle 80, for allowing the steering wheel 88 and the shaft 20 to be rotated and moved downwardly relative to the cylinder housing 11 and the vehicle 80.

The shaft 20 includes a bore 23 formed therein, and includes one or more guiding ribs 24 formed in the lower portion 21 thereof and extended into the bore 23 thereof. One or more bearings 25 may be disposed between the cylinder housing 11 and the lower portion 21 of the shaft 20 for allowing the shaft 20 to be rotated and moved downwardly relative to the cylinder housing 11. A typical coupling device 30 is coupled to the front wheels 82 of the vehicle 80, for controlling or maneuvering the front wheels 82 or for steering purposes. The coupling device 30 includes a link 31 for coupling to the shaft 20, and includes one or more guiding ribs or teeth 32 formed or provided on the upper portion 33 thereof for engaging with the guiding ribs 24 of the shaft 20 and for allowing the front wheels 82 to be controlled or maneuvered or steered or rotated by the steering wheel 88. The upper portion 33 of the link 31 is thus partially engageable into the bore 23 of the shaft 20, and the coupling device 30 is typical and will not be described in further details.

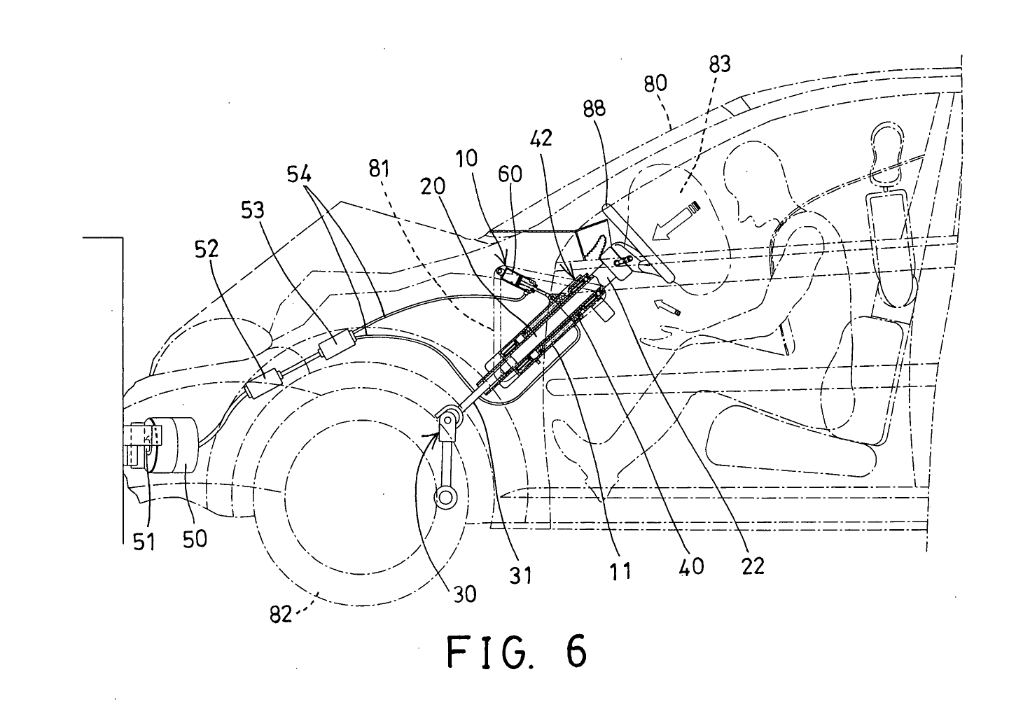

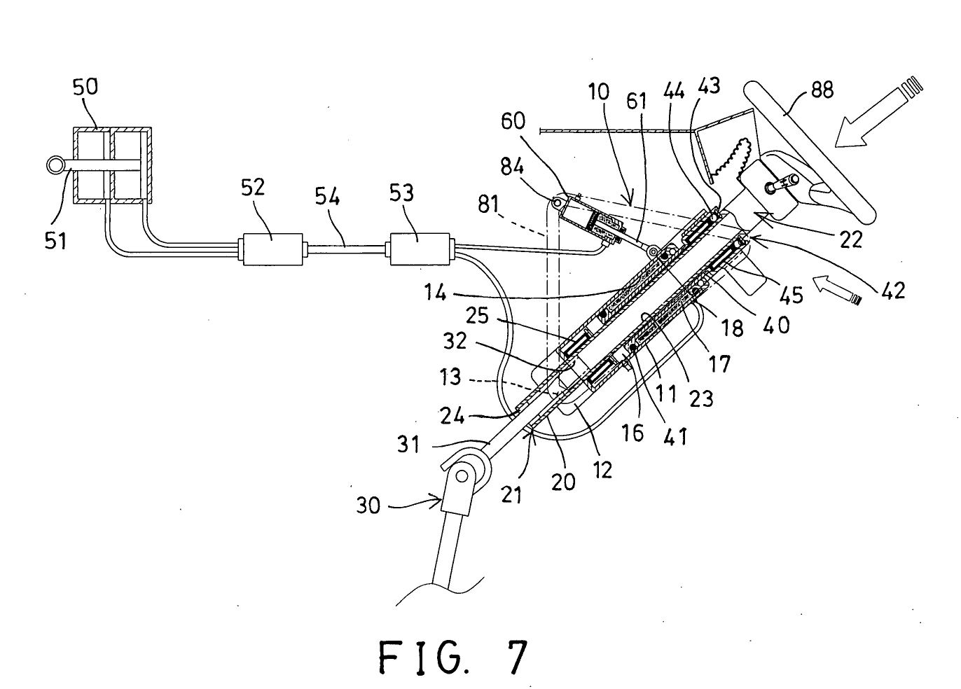

In operation, as shown in FIGS. 1, 2 and 3, when the guiding ribs or teeth 32 of the link 31 of the coupling device 30 are meshed or engaged with the guiding ribs 24 of the shaft 20, the front wheels 82 may be controlled or maneuvered or steered or rotated by the steering wheel 88 to control the driving direction of the vehicle 80. However, as shown in FIGS. 6 and 7, when the guiding ribs or teeth 32 of the link 31 of the coupling device 30 are disengaged from the guiding ribs 24 of the shaft 20, the front wheels 82 may no longer be controlled or maneuvered or steered or rotated by the steering wheel 88. This condition may be occurred or happened when the steering wheel 88 and the shaft 20 have been retracted or moved downwardly relative to the cylinder housing 11 and the vehicle 80.

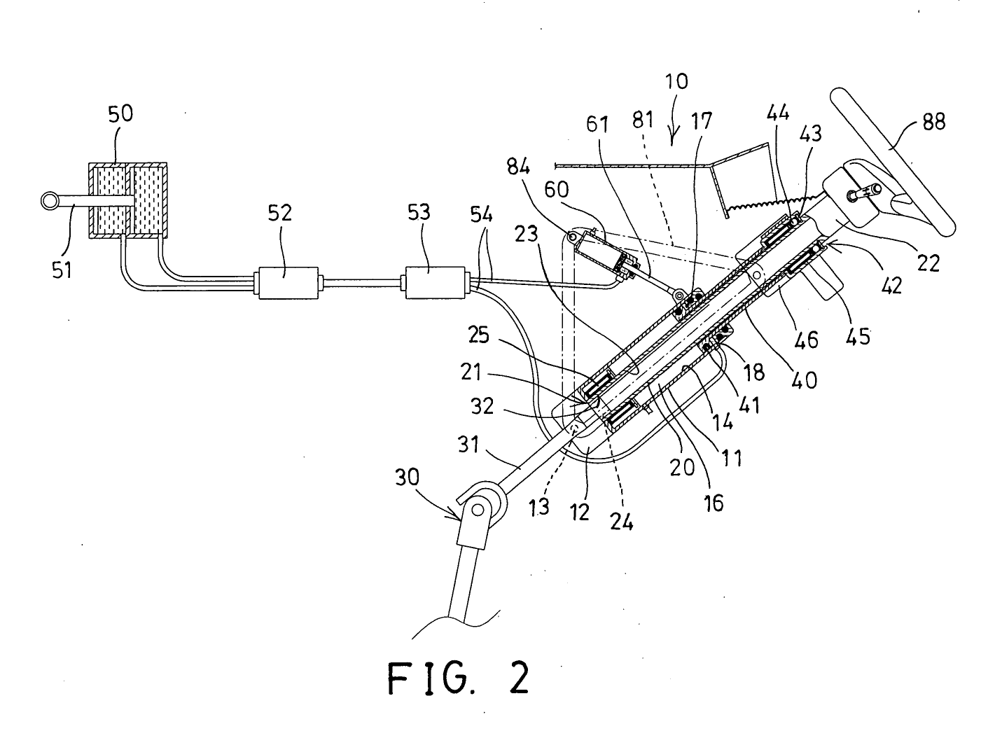

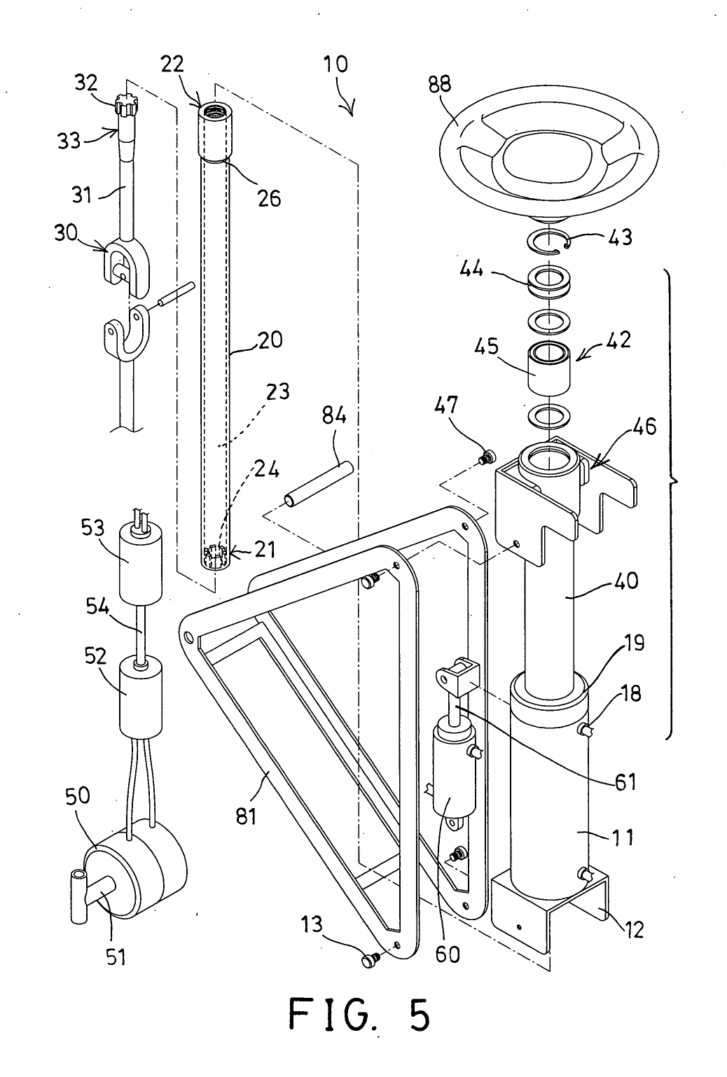

A sleeve or piston rod 40 is slidably engaged onto the shaft 20 and includes a piston 41 formed or provided on the lower end or lower portion thereof, the piston 41 is slidably engaged in the chamber 14 of the cylinder housing 11 for separating the chamber 14 of the cylinder housing 11 into two spaces 16, 17 or a first space 16 and a second space 17 (FIGS. 2-3 and 7). A bearing device 42 is attached or coupled between the upper end or upper portion 46 of the piston rod 40 and the upper end or upper portion of the shaft 20 and includes a clamping or retaining ring 43 engaged between the piston rod 40 and the shaft 20 for rotatably coupling the piston rod 40 and the shaft 20 but for preventing the piston rod 40 and the shaft 20 from moving longitudinally or axially relative to each other. The upper portion of the shaft 20 may include a peripheral groove 26 formed therein (FIG. 5) for engaging with the clamping or retaining ring 43.

The bearing device 42 may include one or more thrust bearings 44 and/or one or more needle bearings 45 disposed between the piston rod 40 and the shaft 20 for facilitating the rotational movement between the piston rod 40 and the shaft 20 and for preventing the piston rod 40 and the shaft 20 from moving longitudinally or axially relative to each other. In operation, when the front wheels 82 are controlled or maneuvered or steered or rotated by the steering wheel 88 and the shaft 20, the shaft 20 may be rotated relative to the cylinder housing 11 and the vehicle 80, and the sleeve or piston rod 40 is not required to be rotated relative to the cylinder housing 11 and the vehicle 80.

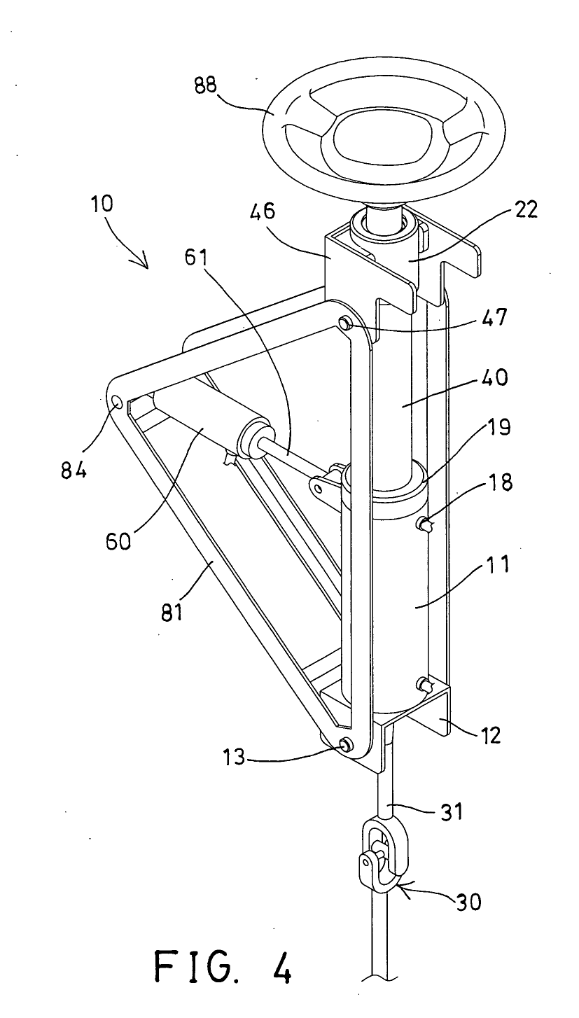

The upper end or upper portion 46 of the piston rod 40 may be temporarily attached or coupled to such as the frame 81 of the vehicle 80 with one or more breakable latches 47 (FIGS. 4, 5) which may be selectively broken when the piston rod 40 and the steering wheel 88 and the shaft 20 are moved or retracted relative to the cylinder housing 11 and the vehicle 80, for example, or when a car accident is happened or occurred, and the operation or the retraction of the piston rod 40 relative to the cylinder housing 11 will be discussed hereinafter.

One or more cylinders or actuators 50 are attached to the outer peripheral portion of the vehicle 80 and each include a piston rod 51 extended outwardly therefrom and directed or extended outwardly relative to the vehicle 80 for allowing the actuators 50 to be actuated or operated when the vehicle is hit by other objects or when the vehicle is stricken onto other objects. One or more check valves 52 and one or more relief valves 53 may further be provided and coupled to the actuator 50 with one or more hoses 54, and may then be coupled to one or more inlet ports 18 of the cylinder housing 11, in which the inlet ports 18 are coupled to or communicated with the space 17 of the cylinder housing 11, for supplying the pressurized air or fluid or hydraulic oil into the space 17 of the cylinder housing 11 and for operating or retracting the piston rod 40 relative to the cylinder housing 11.

In operation, when a car accident is happened or occurred, or when the vehicle is hit by other objects, or when the vehicle is stricken onto other objects, the actuators 50 may be actuated or operated to supply the pressurized air or fluid or hydraulic oil into the space 17 of the cylinder housing 11 and thus to operate or retract the piston rod 40 relative to the cylinder housing 11, in order to retract or to move the steering wheel 88 relative to the vehicle 80 and to move the steering wheel 88 away from the vehicle driver, and thus for increasing the distance between the vehicle driver and the steering wheel 88, and thus for preventing the vehicle driver from striking onto the steering wheel 88 or for cushioning the vehicle driver when the car accident is-happened or occurred. The increasing of the distance between the vehicle driver and the steering wheel 88 may also be used to suitably reduce the force applied to the vehicle driver by the air bag 83 (FIG. 6).

A further cylinder or actuating device 60 may further be or optionally be provided and attached or secured to the vehicle 80, such as secured to the frame 81 of the vehicle 80 with a pivot coupler 84 (FIG. 5) and includes a piston rod 61 coupled to the cylinder housing 11 for further retracting or moving the steering wheel 88 relative to the vehicle 80 or for further moving the steering wheel 88 away from the vehicle driver, and thus for further increasing the distance between the vehicle driver and the steering wheel 88. It is to be noted that the breakable latches 47 may be arranged to be selectively broken when the piston rod 40 and the steering wheel 88 and the shaft 20 are moved or retracted relative to the cylinder housing 11 and the vehicle 80.

It is to be noted that the typical vehicles failed to provide any retracting or moving means or device for retracting or moving the steering wheel 88 relative to the vehicle 80 and/or the vehicle driver, such as for retracting or moving the steering wheel 88 downwardly and/or forwardly relative to the vehicle 80 and/or the vehicle driver, or away from the vehicle driver for increasing the distance between the vehicle driver and the steering wheel 88, and thus for preventing the vehicle driver from quickly striking onto the steering wheel 88.

Accordingly, the steering wheel retracting device in accordance with the present invention may be provided for attaching to a vehicle and for retracting the steering wheel of the vehicle and/or for moving the steering wheel away from the vehicle driver when the vehicle is hit or stricken onto other objects, and thus for preventing the vehicle driver from striking onto the steering wheel when a car accident is happened.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A steering wheel retracting device comprising:
a steering wheel provided in a vehicle, and
means for moving said steering wheel relative to the vehicle to selectively move said steering wheel away from a vehicle driver when a car accident is happened.

2. The steering wheel retracting device as claimed in claim 1, wherein said moving means includes a cylinder housing for attaching to the vehicle and having a chamber formed therein, and a shaft engaged through said chamber of said cylinder housing and having an upper portion attached to said steering wheel.

3. The steering wheel retracting device as claimed in claim 2, wherein said cylinder housing includes at least one bearing disposed between said cylinder housing and said shaft.

4. The steering wheel retracting device as claimed in claim 2, wherein said shaft includes a bore formed therein, a coupling device is provided for coupling to front wheels of the vehicle and includes a link having an upper portion engageable into said bore of said shaft for coupling said steering wheel to the front wheels of the vehicle.

5. The steering wheel retracting device as claimed in claim 4, wherein said shaft includes at least one guiding rib formed therein and extended into said bore of said shaft, and said link includes at least one guiding rib provided on said upper portion of said link for engaging with said at least one guiding rib of said shaft and allowing said link of said coupling device to be rotated by said shaft.

6. The steering wheel retracting device as claimed in claim 2, wherein said moving means includes a piston rod slidably engaged onto said shaft and includes a piston provided on said piston rod and slidably engaged in said chamber of said cylinder housing for separating said chamber of said cylinder housing into a first space and a second space, and an actuator coupled to said second space of said cylinder housing for selectively moving said piston relative to said cylinder housing.

7. The steering wheel retracting device as claimed in claim 6, wherein a bearing device is coupled between said piston rod and said shaft for rotatably coupling said piston rod and said shaft together but for preventing said piston rod and said shaft from moving axially relative to each other.

8. The steering wheel retracting device as claimed in claim 7, wherein said bearing device includes at least one thrust bearing disposed between said piston rod and said shaft.

9. The steering wheel retracting device as claimed in claim 7, wherein said bearing device includes at least one needle bearing disposed between said piston rod and said shaft.

10. The steering wheel retracting device as claimed in claim 6, wherein a retaining ring is engaged between said piston rod and said shaft for rotatably coupling said piston rod and said shaft together.

11. The steering wheel retracting device as claimed in claim 6, wherein said moving means includes at least one breakable latch for coupling said piston rod to the vehicle and for being selectively broken when said piston rod is moved relative to said cylinder housing.

12. The steering wheel retracting device as claimed in claim 11, wherein said moving means includes a frame for attaching to the vehicle and for attaching said at least one breakable latch.

13. The steering wheel retracting device as claimed in claim 6, wherein said actuator includes an outwardly extended piston rod for being actuated to supply a pressurized fluid to said second space of said cylinder housing.

14. The steering wheel retracting device as claimed in claim 6, wherein said actuator includes at least one check valve coupled between said cylinder housing and actuator.

15. The steering wheel retracting device as claimed in claim 6, wherein said actuator includes at least one relief valve coupled between said cylinder housing and actuator.

16. The steering wheel retracting device as claimed in claim 1, wherein said moving means includes an actuating device having a piston rod coupled to said cylinder housing for selectively moving said cylinder housing and said steering wheel away from the vehicle driver.

17. The steering wheel retracting device as claimed in claim 16, wherein said moving means includes a frame for attaching to the vehicle and for attaching said actuating device.

18. The steering wheel retracting device as claimed in claim 16, wherein said moving means includes an actuator coupled to said actuating device for selectively actuating said actuating device to move said cylinder housing and said steering wheel away from the vehicle driver.
